(19) United States
(12) Patent Application Publication
(10) Pub. No.: US 2022/0114202 A1
(43) Pub. Date: Apr. 14, 2022

(54) SUMMARY GENERATION APPARATUS, CONTROL METHOD, AND SYSTEM

(71) Applicant: KONICA MINOLTA, INC., Tokyo (JP)

(72) Inventor: Takashi KUWABARA, Toyohashi-shi (JP)

(73) Assignee: KONICA MINOLTA, INC., Tokyo (JP)

(21) Appl. No.: 17/473,341

(22) Filed: Sep. 13, 2021

(30) Foreign Application Priority Data
Oct. 13, 2020 (JP) 2020-172358

(51) Int. Cl. G06F 16/34; G06F 16/33; G06F 16/35; G06F 40/268

(52) U.S. Cl. CPC G06F 16/345; G06F 40/268; G06F 16/35; G06F 16/3334

(57) ABSTRACT

A summary generation apparatus generates a summary from language data, and includes a hardware processor that: classifies a word included in the language data and generates a plurality of word clusters in such a manner that words having a possibility of being related to one topic belong to an identical word cluster; selects a representative word cluster including words related to a topic representing description content of the language data from the plurality of word clusters; and generates a summary from the language data on the basis of the representative word cluster.

The entire disclosure of Japanese patent Application No. 2020-172358, filed on Oct. 13, 2020, is incorporated herein by reference in its entirety.

### BACKGROUND

### Technological Field

The present disclosure relates to techniques for summarizing documents.

### Description of the Related art

In general, many companies and the like refer to manually created memos and create arrangement and meeting minutes using document editors.

On the other hand, in order to reduce the number of man-hours for manually creating meeting minutes, there has been proposed a meeting minute creating system that recognizes a voice uttered in proceeding of a meeting by using a voice recognition technology and automatically transcribes word by word. Furthermore, a technique of summarizing a document by performing document structure analysis processing on a document obtained by transcribing has been proposed.

As these summarization generating techniques, known summarization techniques of natural language processing are used (see, for example, Gunes Erkan et al., LexRank: Graph-based Lexical Centrality as Salience in Text Summarization, the Internet <URL: https://www.cs.cmu.edu/afs/cs/project/jair/pub/volume22/erkan04a-html/erkan04a.html>). In these summary techniques, frequently appearing words included in a document to be summarized are detected, and a sentence including many frequently appearing words is extracted as a summary from the document to be summarized.

According to known summary techniques such as Gunes Erkan et al., LexRank: Graph-based Lexical Centrality as Salience in Text Summarization, the Internet <URL: https://www.cs.cmu.edu/afs/cs/project/jair/pub/volume22/erkan04a-html/erkan04a.html>, sentences including many frequently appearing words are extracted as a summary, and thus when the frequently appearing words are words having little relationship with a topic representing the description content of the document, there is a problem that the extracted summary does not represent the representative topic.

### SUMMARY

An object of the present disclosure is to provide a summary generation apparatus, a control method, and a system capable of solving such a problem and generating a summary representing a representative topic.

To achieve the abovementioned object, according to an aspect of the present invention, there is provided a summary generation apparatus that generates a summary from language data, and the summary generation apparatus reflecting one aspect of the present invention comprises a hardware processor that: classifies a word included in the language data and generates a plurality of word clusters in such a manner that words having a possibility of being related to one topic belong to an identical word cluster; selects a representative word cluster including words related to a topic representing description content of the language data from the plurality of word clusters; and generates a summary from the language data on the basis of the representative word cluster.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an appearance of an information processing apparatus according to an embodiment;

FIG. 2 is a block diagram illustrating a configuration of a main device of the information processing apparatus;

FIG. 3 illustrates content of a document;

FIG. 4 illustrates content of noun phrase data;

FIG. 5 illustrates an example of a data structure of a word frequency matrix;

FIG. 6 illustrates word distributions for each topic and topic distributions for each document;

FIGS. 7A to 7C illustrate content of word clusters;

FIG. 8 illustrates content of a cluster probability data table;

FIG. 9 illustrates content of a summary;

FIG. 10 illustrates a screen displayed on a monitor of the information processing apparatus;

FIG. 11A illustrates content of prior knowledge data;

FIG. 11B illustrates content of outlier data;

FIG. 12 is a flowchart illustrating an operation in the information processing apparatus;

FIG. 13 is a flowchart illustrating an operation of referring to setting data;

FIG. 14 is a flowchart illustrating an operation of processing of outlier;

FIG. 15 is a flowchart illustrating an operation of word cluster inheritance processing;

FIG. 16 illustrates how to generate a summary text from a document 1 and a document 4; and

FIG. 17 illustrates how to generate a summary text from two paragraphs of a document 1 and one paragraph of a document 3.

### DETAILED DESCRIPTION OF EMBODIMENTS

Hereinafter, one or more embodiments of the present invention will be described with reference to the drawings. However, the scope of the invention is not limited to the disclosed embodiments.

### 1 Embodiment

An information processing apparatus 10 as an embodiment of the present disclosure will be described.

### 1.1 Information Processing Apparatus 10

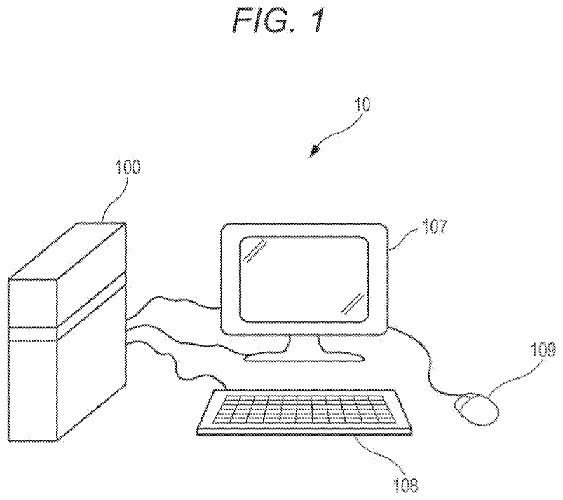

The information processing apparatus 10 (summary generation apparatus) is a general computer system, for example, a personal computer. The information processing apparatus 10 generates a summary from a document. As illustrated in FIG. 1, the information processing apparatus 10 is configured by connecting a monitor 107, a keyboard 108, and a mouse 109 to a main device 100.

Here, the document is a newspaper article, a literature work, a paper, a book, or the like expressed in a language such as Japanese, English, or French, and generally includes a plurality of chapters, a plurality of clauses, and a plurality of paragraphs, and each chapter, each clause, and each paragraph includes a plurality of sentences. Each sentence is formed by arranging a plurality of words. In order to enable handling by the information processing apparatus 10, the document is expressed and stored in a computer-readable format. Here, one or more documents, one or more chapters, one or more clauses, one or more paragraphs, and one or more sentences are language data. In particular, in the present specification, a collection of a plurality of documents may be referred to as language data. Note that figures, photographs, graphs, and the like may be included inside the document, but in the information processing apparatus 10, these figures, photographs, graphs, and the like are not targets of summary generation.

### 1.2 Main Device 100

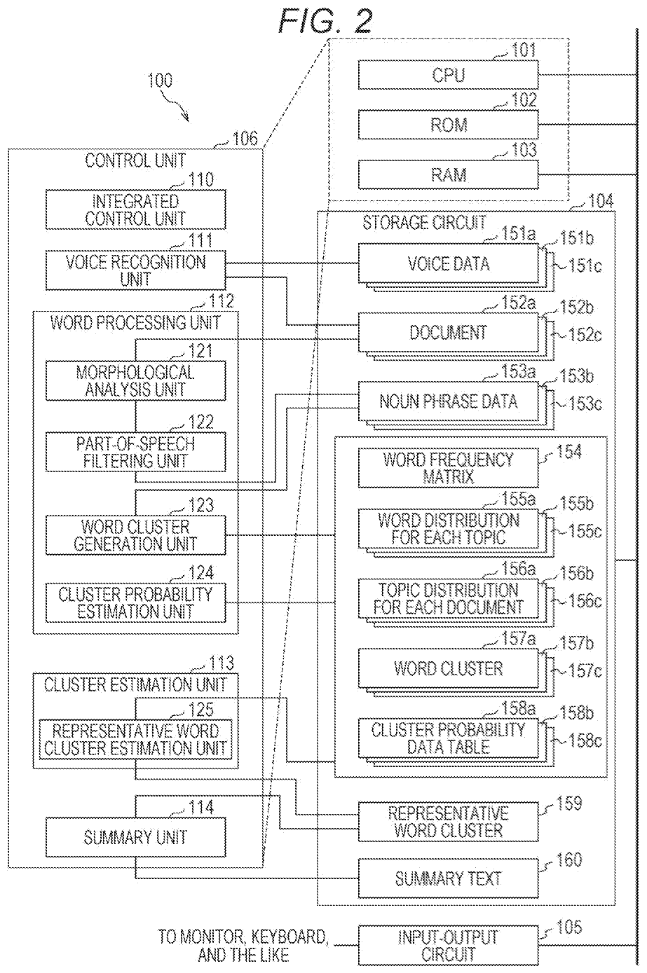

As illustrated in FIG. 2, the main device 100 includes a CPU 101, a ROM 102, a RAM 103, a storage circuit 104, an input-output circuit 105, and the like.

The CPU 101, the ROM 102, and the RAM 103 form a control unit 106.

The RAM 103 stores various control variables, set parameters, and the like, and provides a work area when the CPU 101 executes a program.

The ROM 102 stores a control program (computer program) and the like for executing operations in the main device 100.

The main device 100 may further include a hard disk unit, and the hard disk unit may store a control program for executing operations in the main device 100, and the like.

The CPU 101 operates according to the control program stored in the ROM 102 or the hard disk unit.

By the CPU 101 operating according to the control program, the control unit 106 functionally configures an integrated control unit 110, a voice recognition unit 111, a word processing unit 112, a cluster estimation unit 113, and a summary unit 114. The word processing unit 112 (word processor) includes a morphological analysis unit 121, a part-of-speech filtering unit 122, a word cluster generation unit 123, and a cluster probability estimation unit 124. Further, the cluster estimation unit 113 also includes a representative word cluster estimation unit 125.

The integrated control unit 110 integrally controls the voice recognition unit 111, the word processing unit 112, the cluster estimation unit 113, the summary unit 114, and the like.

Further, the integrated control unit 110 receives an operation of the user from the keyboard 108 (receiver) via the input-output circuit 105. The operation of the user includes an instruction to start summarization processing, setting of various parameters, and the like. For example, in a case where the operation of the user is an instruction to start summarization processing, the integrated control unit 110 integrally controls the voice recognition unit 111, the word processing unit 112, the cluster estimation unit 113, the summary unit 114, and the like to generate a summary text.

The input-output circuit 105 receives an input signal from the keyboard 108 or the mouse 109, and outputs the received input signal to the integrated control unit 110. Further, the input-output circuit 105 receives data for display, for example, data for a screen from the integrated control unit 110, outputs the received data to the monitor 107, and causes the monitor 107 to display the data.

The storage circuit 104, the voice recognition unit 111, the word processing unit 112, the cluster estimation unit 113, and the summary unit 114 will be described below.

### 1.3 Storage Circuit 104

The storage circuit 104 (storage) includes, for example, a nonvolatile semiconductor memory or the like. Of course, the storage circuit 104 may include a hard disk.

The storage circuit 104 includes regions for storing voice data 151a, 151b, and 151c, documents 152a, 152b, and 152c, noun phrase data 153a, 153b, and 153c, a word frequency matrix 154, word distributions 155a, 155b, and 155c for each topic, topic distributions 156a, 156b, and 156c for each document, word clusters 157a, 157b, and 157c, cluster probability data tables 158a, 158b, and 158c, a representative word cluster 159, and a summary text 160.

(1) Voice Data 151a, 151b, and 151c

Each piece of the voice data 151a, 151b, and 151c is recorded data obtained by recording minutes of another meeting. The voice data 151a, 151b, and 151c is configured in an audio file format according to, for example, MP3 (MPEG-1 Audio Layer-3).

(2) Documents 152a, 152b, and 152c

The documents 152a, 152b, and 152c are composed of text data generated by performing voice recognition processing on the voice data 151a, 151b, and 151c, respectively, by the voice recognition unit 111.

The documents 152a, 152b, and 152c are identified by document IDs “D001”, “D002”, and “D003”, respectively.

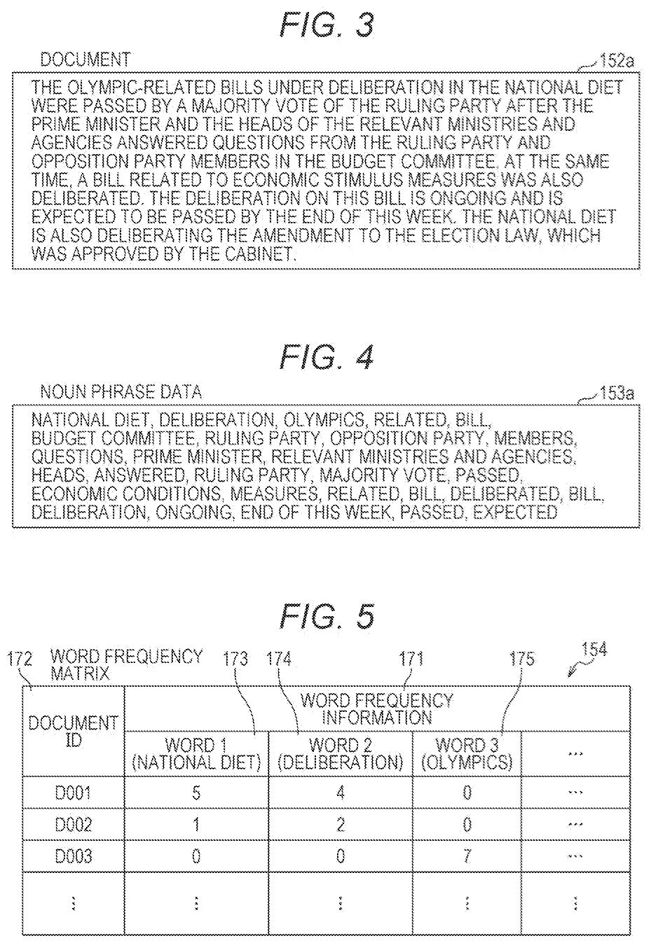

An example of the document 152a is illustrated in FIG. 3. As illustrated in this diagram, the document 152a includes text data including a plurality of sentences.

(3) Noun Phrase Data 153a, 153b, and 153c

Each piece of the noun phrase data 153a, 153b, and 153c is data including noun phrases extracted by performing morphological analysis and part-of-speech filtering on the text data included in the documents 152a, 152b, and 152c, respectively, by the morphological analysis unit 121 and the part-of-speech filtering unit 122. Each piece of the noun phrase data 153a, 153b, and 153c includes a plurality of noun phrases.

An example of the noun phrase data 153a is illustrated in FIG. 4. As illustrated in this diagram, the noun phrase data 153a includes a plurality of noun phrases extracted from the document 152a.

(4) Word Frequency Matrix 154

The word frequency matrix 154 is a data table obtained by aggregating frequencies of each of the noun phrases (hereinafter referred to as words) included in the noun phrase data 153a, 153b, and 153c by the word cluster generation unit 123.

As an example, as illustrated in FIG. 5, the word frequency matrix 154 includes a plurality of sets each including a document ID and word frequency information, and each piece of word frequency information includes a frequency of each word included in the document.

As illustrated in this diagram, for example, the noun phrase data 153a generated from a document 152a identified by a document ID “D001” includes five words “National Diet”, four words “deliberation”, and no word “Olympics”.

Further, for example, the noun phrase data 153b generated from the document 152b identified by the document ID “D002” includes one word “National Diet”, two words “deliberation”, and no word “Olympics”.

Furthermore, for example, the noun phrase data 153c generated from the document 152c identified by the document ID “D003” does not include the word “National Diet” and the word “deliberation”, and includes seven words “Olympics”.

(5) Word Distribution 155a, 155b, and 155c for each Topic

Each of the word distributions 155a, 155b, and 155c for each topic is a data table indicating the distribution of the frequencies of words generated by the word cluster generation unit 123 by each topic using the word frequency matrix 154 aggregated from the noun phrase data 153a, 153b, and 153c and the positional relationship between the words in each document. Note that a classification method for extracting a topic using a positional relationship between words in each document will be described later.

Here, the positional relationship between words in the document refers to, for example, a relationship between a plurality of words included in one sentence in the document. It can be said that a plurality of words included in one sentence is related to one topic (for example, a topic related to “politics”) and have a close relationship with each other.

Further, the positional relationship between words in the document refers to, for example, a relationship between a word included in one sentence in the document and a word included in a sentence arranged in the forward direction or the backward direction of the sentence in succession to the sentence. It can be said that words included in two consecutive sentences are also related to one topic and have a close relationship with each other.

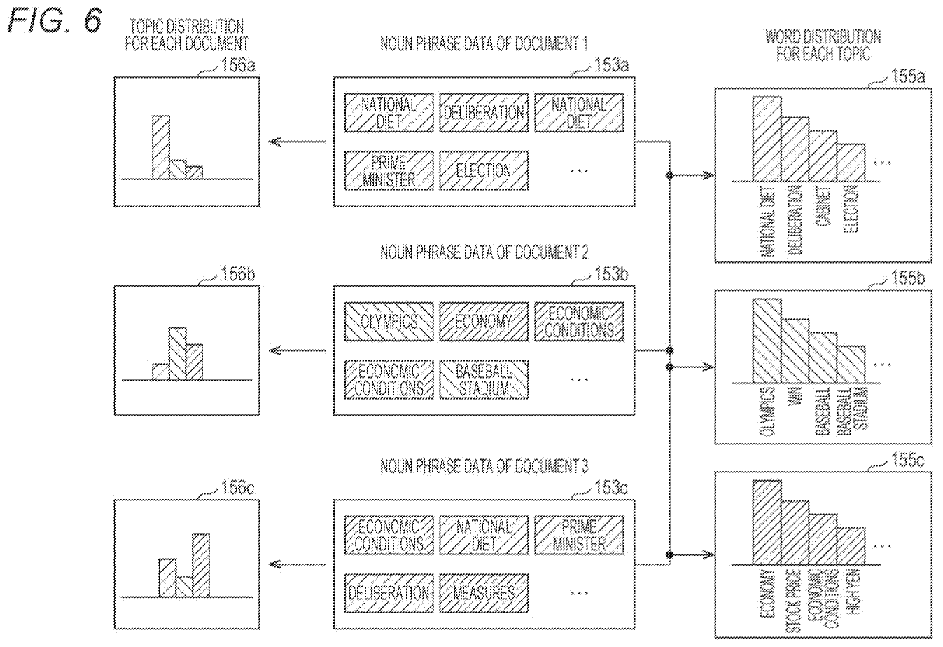

For example, the word distribution 155a is a data table in which, for one topic (for example, a topic related to “politics”), the frequency of words related to the topic is aggregated by each word from the entire noun phrase data 153a, 153b, and 153c. FIG. 6 diagrammatically illustrates the word distribution 155a. The word distribution 155a illustrated in this diagram is represented by a bar graph in which words included in the data table are arranged on a horizontal axis and the frequency of each word is arranged on a vertical axis.

Further, for example, the word distribution 155b is a data table generated from the entire noun phrase data 153a, 153b, and 153c for another topic (for example, a topic related to “sports”) different from the aforementioned topic, similarly to the word distribution 155a. FIG. 6 diagrammatically illustrates the word distribution 155b.

Furthermore, for example, the word distribution 155c is a data table generated from the entire noun phrase data 153a, 153b, and 153c for another topic (for example, a topic related to “economy”) different from the two aforementioned topics, similarly to the word distribution 155a. FIG. 6 diagrammatically illustrates the word distribution 155c.

(6) Topic Distribution 156a, 156b, and 156c for each Document

The topic distributions 156a, 156b, and 156c for each document are data tables indicating distributions of index values (described later) of topics generated from the noun phrase data 153a, 153b, and 153c for the documents 152a, 152b, and 152c, respectively, by the cluster estimation unit 113.

For example, the topic distribution 156a is a data table obtained by aggregating index values by each topic by each topic from the noun phrase data 153a for one document 152a. FIG. 6 diagrammatically illustrates the topic distribution 156a. The topic distribution 156a illustrated in this diagram is represented by a bar graph in which topics included in the data table are arranged on a horizontal axis, and probabilities (described later) of words belonging to each topic are arranged on a vertical axis.

Further, for example, the topic distribution 156b is a data table generated for one document 152b similarly to the topic distribution 156a. FIG. 6 diagrammatically illustrates the topic distribution 156b.

Furthermore, for example, the topic distribution 156c is a data table generated for one document 152c similarly to the topic distribution 156a. FIG. 6 diagrammatically illustrates the topic distribution 156c.

(7) Word Clusters 157a, 157b, and 157c

The word cluster 157a is a word group generated by the word cluster generation unit 123 by collecting, as one topic, words similar in meaning, that is, words having close relationships with each other (words having a possibility of being related to one topic with each other) from the noun phrase data 153a for the document 152a according to the frequencies of words appearing in the noun phrase data 153a and the positional relationship of words in the document 152a.

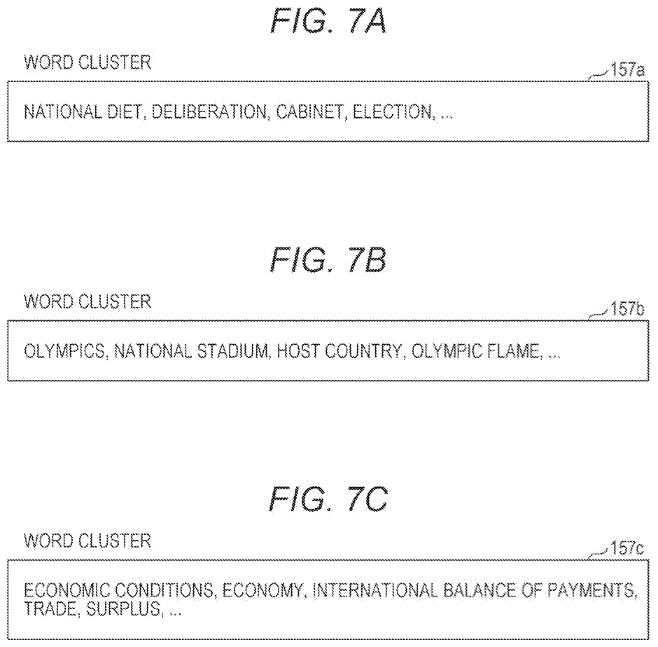

An example of the word cluster 157a is illustrated in FIG. 7A. As illustrated in this diagram, the word cluster 157a includes words such as “National Diet”, “deliberation”, “cabinet”, and “election”.

Further, similarly to the word cluster 157a, the word cluster 157b is a word group generated by the word cluster generation unit 123 by collecting, as one topic, words similar in meaning, that is, words having close relationships with each other, from the noun phrase data 153a for the document 152a.

An example of the word cluster 157b is illustrated in FIG. 7B. As illustrated in this diagram, the word cluster 157b includes words such as “Olympics”, “national stadium”, “host country”, and “Olympic flame”.

Further, similarly to the word cluster 157a, the word cluster 157c is a word group generated by the word cluster generation unit 123 by collecting, as one topic, words similar in meaning, that is, words having close relationships with each other, from the noun phrase data 153a for the document 152a.

An example of the word cluster 157c is illustrated in FIG. 7C. As illustrated in this diagram, the word cluster 157c includes words such as “economic conditions”, “economy”, “international balance of payments”, and “trade”.

Note that, in the above description, three word clusters are generated from one document, but the embodiment is not limited to this. One, two, or four or more word clusters may be generated from one document.

Further, for each of the documents 152b and 152c, one or a plurality of word clusters is generated similarly to as described above.

(8) Cluster Probability Data Tables 158a, 158b, and 158c

The cluster probability data table 158a includes a probability of each noun phrase (word) obtained by adjustment for the document 152a by the word cluster generation unit 123 according to the frequencies (that is, the frequencies included in the word frequency matrix 154) of words appearing in the noun phrase data 153a from the noun phrase data 153a and the positional relationship between a word and a word in the document 152a.

Here, the probability of a word indicates a degree of a possibility that each word belonging to each word cluster belongs to a topic corresponding to the word cluster.

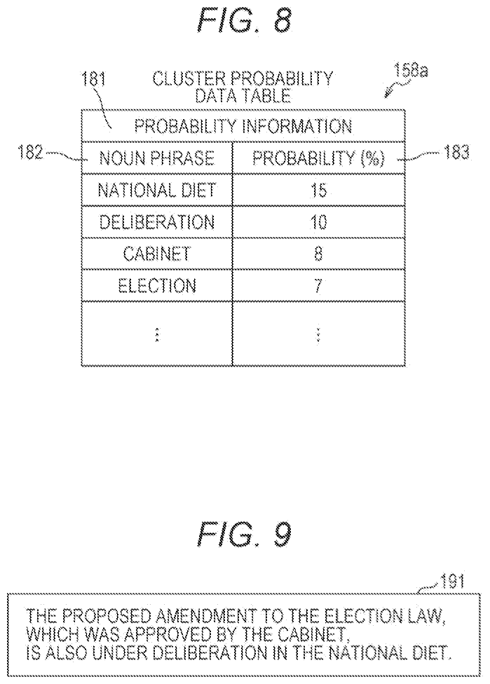

As illustrated in FIG. 8, the cluster probability data table 158a includes a plurality of pieces of probability information, and each piece of probability information includes a noun phrase and a probability.

Here, the noun phrase is a noun phrase included in the noun phrase data 153a, and the probability is a probability of the noun phrase.

Further, similarly to the cluster probability data table 158a, the cluster probability data table 158b is formed by the word cluster generation unit 123 by associating the noun phrase generated from the noun phrase data 153b with the probability for the document 152b.

Furthermore, similarly to the cluster probability data table 158a, the cluster probability data table 158c is formed by the word cluster generation unit 123 by associating the noun phrase generated from the noun phrase data 153c with the probability for the document 152c.

(9) Representative Word Cluster 159

The representative word cluster 159 is one word cluster selected by the representative word cluster estimation unit 125 from the word clusters 157a, 157b, and 157c for the document 152a.

The representative word cluster is also selected for each of the documents 152b and 152c.

(10) Summary Text 160

The summary text 160 is a summary text containing a summary generated by the summary unit 114 for the document 152a. The summary text 160 includes one or more sentences.

FIG. 9 illustrates, as an example, a summary 191 extracted from the document 152a.

A summary text is also generated for each of the documents 152b and 152c.

### 1.4 Voice Recognition Unit 111

The voice recognition unit 111 (voice recognition unit) converts the content of utterances (voice data) in a discussion of a meeting or the like into text data to generate a document (language data) including the text data, and writes the generated document in the storage circuit 104.

Under control of the integrated control unit 110, the voice recognition unit 111 specifies a section matching a phoneme pattern of vowel sound, consonant sound, and syllabic nasal for each voice data stored in the storage circuit 104, and generates a sequence of identifiers (for example, a kana character string) representing phonemes. Next, the voice recognition unit 111 searches for a generated expression in Chinese character-kana mixed notation corresponding to the kana character string from a built-in dictionary, replaces the obtained expression with the generated kana character string, and generates text data.

In this manner, the voice recognition unit 111 generates a document including text data from the voice data, attaches a document ID for identifying the document to the generated document, and writes the document in the storage circuit 104.

1.5 Word Processing Unit 112

Under the control of the integrated control unit 110, the word processing unit 112 (word processing unit) performs morphological analysis on the document, performs the part-of-speech filtering, generates word clusters, and estimates the probability of each word as follows. The word processing unit 112 classifies words included in the document (language data) so that words having a possibility of being related to one topic belong to the same word cluster, and generates a plurality of word clusters. Further, the word processing unit 112 estimates a probability indicating a degree of a possibility that each word belonging to each generated word cluster belongs to a topic corresponding to the word cluster.

As described above, the word processing unit 112 includes the morphological analysis unit 121, the part-of-speech filtering unit 122, the word cluster generation unit 123, and the cluster probability estimation unit 124.

As will be described later, the word cluster generation unit 123 and the cluster probability estimation unit 124 use, for example, Latent Dirichlet Allocation (LDA) as a known natural language processing technique.

(1) Morphological Analysis Unit 121

The morphological analysis unit 121 reads each document (language data) from the storage circuit 104 under the control of the integrated control unit 110. Next, a morphological analysis is performed on the text data included in the read document, and the text data is decomposed to generate a plurality of morphemes. Furthermore, the morphological analysis unit 121 estimates a part of speech for each of the plurality of generated morphemes, and adds part-of-speech information indicating the estimated part of speech to each morpheme (word).

The morphological analysis unit 121 outputs morphemes which are extracted from each document and to which part-of-speech information indicating the part of speech is added to the part-of-speech filtering unit 122.

(2) Part-of-Speech Filtering Unit 122

The part-of-speech filtering unit 122 receives the morphemes (words) to which the part-of-speech information indicating the part of speech is added from the morphological analysis unit 121.

Upon receiving the morpheme to which the part of speech is added, the part-of-speech filtering unit 122 extracts a morpheme (word) to which the part-of-speech information indicating a noun is added as the part of speech from the morphemes to which the part-of-speech information indicating the part of speech is added by the morphological analysis unit 121. The extracted morpheme is referred to as a noun phrase. Note that the noun includes a proper noun.

The part-of-speech filtering unit 122 writes noun phrase data including the extracted noun phrases in the storage circuit 104.

In this manner, the noun phrase data 153a, 153b, and 153c is written in the storage circuit 104 for the documents 152a, 152b, and 152c, respectively.

(3) Word Cluster Generation Unit 123

(Aggregation of Appearance Frequency of Word)

The word cluster generation unit 123 aggregates an appearance frequency of a word by each word from the noun phrase data 153a for the document 152a under the control of the integrated control unit 110. The word cluster generation unit 123 writes the appearance frequency of the word aggregated by each word in the word frequency information 171 corresponding to the document 152a (that is, the document ID “D001”) in the word frequency matrix 154.

Further, similarly to as described above, the word cluster generation unit 123 aggregates the appearance frequency of a word for each word from the noun phrase data 153b and 153c for the documents 152b and 152c, and writes the aggregated frequency in the word frequency information 171 corresponding to the documents 152b and 152c in the word frequency matrix 154.

(Extraction of Word having Predetermined Positional Relationship)

Next, the word cluster generation unit 123 extracts a plurality of words having the above-described positional relationship for each sentence included in the documents 152a, 152b, and 152c.

As an example, the word cluster generation unit 123 extracts one sentence from the document 152a. Next, the word cluster generation unit 123 extracts a plurality of words included in the extracted sentence from the noun phrase data 153a. Thus, the plurality of extracted words is regarded as having one positional relationship. For example, the word cluster generation unit 123 extracts words “National Diet”, “deliberation”, “Olympics”, “association”, “bill”, and the like from one extracted sentence. The extracted words “National Diet”, “deliberation”, “Olympics”, “association”, “bill”, and the like are considered to have one positional relationship. The word cluster generation unit 123 executes the above processing for all the sentences included in the document 152a. Further, the word cluster generation unit 123 also executes the above processing for each sentence included in the documents 152b and 152c.

Further, as another example, the word cluster generation unit 123 may extract two sentences consecutively arranged in front and back from the document 152a. Next, the word cluster generation unit 123 extracts a plurality of words included in the two extracted sentences from the noun phrase data 153a. Thus, the plurality of extracted words is considered to have one positional relationship. The word cluster generation unit 123 executes the above processing for all the sentences included in the document 152a. The word cluster generation unit 123 also executes the above processing for each of two consecutively arranged sentences included in the documents 152b and 152c.

A plurality of words included in one sentence or a plurality of words included in two sentences arranged consecutively in front and back has common meaning, usage, used field, or the like of each word. That is, it is considered that a plurality of words included in one sentence or the aforementioned two sentences has one positional relationship, and the plurality of words is related to one topic.

When the plurality of words having the positional relationship generated as described above is considered to belong to one group, the same number of groups as the number of generated positional relationships is generated as described above. In a case where one positional relationship is generated from one sentence, the number of generated groups is equal to the number of sentences included in the document. Further, in a case where one positional relationship is generated from two sentences consecutively arranged in front and back, the number of generated groups is equal to the number of combinations of the above two sentences selected from the document.

(Classification for Topic Extraction)

In a case where one word included in the first group and one word included in the second group are the same among the plurality of groups generated as described above, the word cluster generation unit 123 associates the first group with the second group. For example, in a case where the first group includes the word “National Diet” and the second group also includes the word “National Diet”, the first group and the second group are associated with each other. This association is performed for all the groups generated as described above. In this manner, the two groups associated with each other are set as one new group. For example, a first group including the word “National Diet” and a second group including the word “National Diet” are set as a new group. This association is performed for all the generated groups, and the process of associating a group with a group is repeated until the groups can be aggregated into several groups as a whole.

Note that in a case where the first word included in the first group is identical to the second word included in the second group, and the third word included in the first group is identical to the fourth word included in the second group, the first group and the second group may be associated with each other. For example, in a case where the word “National Diet” is included in the first group, the word “National Diet” is also included in the second group, the word “deliberation” is included in the first group, and the word “deliberation” is also included in the second group, the first group and the second group are associated with each other.

Furthermore, the first group and the second group may be associated with each other by increasing the number of words to be associated between the first group and the second group.

Thus, a plurality of words included in one group finally generated has a possibility of relating to one topic (for example, “politics”). Further, a plurality of words included in another group may relate to another topic (for example, “sports”). Here, the finally generated group is referred to as a topic group.

(Generation of Word Distribution for each Topic)

Next, the word cluster generation unit 123 aggregates the frequencies of appearing words for one topic group among the plurality of topic groups using the word frequency matrix 154 and the positional relationship described above for the entire documents 152a, 152b, and 152c (and the noun phrase data 153a, 153b, and 153c), and generates, for example, the word distribution 155a for each topic illustrated in FIG. 6.

Similarly, the word cluster generation unit 123 generates word distributions 155b and 155c for each topic illustrated in FIG. 6, for example, for the other topic groups.

(Generation of Word Cluster)

The word cluster generation unit 123 selects, for example, the word distribution 155a from the word distributions 155a, 155b, and 155c. Next, the word cluster generation unit 123 extracts words included in the document 152a (that is, the noun phrase data 153a) from among the words listed in a horizontal axis direction of the selected word distribution 155a. Next, the word cluster generation unit 123 generates a word cluster including the extracted words. FIG. 7A illustrates the word cluster 157a as an example. This word cluster includes, for example, many words related to “politics”.

Further, the word cluster generation unit 123 selects, for example, the word distribution 155b. Next, the word cluster generation unit 123 extracts words included in the document 152a (that is, the noun phrase data 153a) from among the words listed in the horizontal axis direction of the selected word distribution 155b. Next, the word cluster generation unit 123 generates a word cluster including the extracted words. FIG. 7B illustrates the word cluster 157b as an example. This word cluster includes many words related to “sports”.

Furthermore, the word cluster generation unit 123 selects, for example, the word distribution 155c. Next, the word cluster generation unit 123 extracts words included in the document 152a (that is, the noun phrase data 153a) from among the words listed in the horizontal axis direction of the selected word distribution 155c.

Next, the word cluster generation unit 123 generates a word cluster including the extracted words. FIG. 7C illustrates the word cluster 157c as an example. This word cluster includes many words related to “economy”.

Here, the word cluster generation unit 123 may extract a predetermined number of words whose frequency is higher among the words listed in the selected word distribution.

Further, the word cluster generation unit 123 generates one or more word clusters for the documents 152b and 152c similarly to as described above.

As described above, the word cluster generation unit 123 generates one or more word clusters for one document.

In this manner, the word cluster generation unit 123 classifies the extracted words and generates a plurality of word clusters. Further, the word cluster generation unit 123 aggregates the appearance frequency of an extracted word by each word, obtains a positional relationship between a word and a word in the document (language data), and generates a plurality of word clusters using the aggregated appearance frequency and the obtained positional relationship.

(4) Cluster Probability Estimation Unit 124

The cluster probability estimation unit 124 first randomly sets a probability for each word in each word cluster. Next, the cluster probability estimation unit 124 corrects the probability randomly set to the word using the word distribution corresponding to the word cluster and using the positional relationship described above.

In this manner, for example, the cluster probability estimation unit 124 generates the cluster probability data table 158a for the word cluster 157a of the document 152a as illustrated in FIG. 8. Similarly, the cluster probability estimation unit 124 generates the cluster probability data table for other word clusters of the document 152a. The cluster probability estimation unit 124 writes the probability set for each word in the cluster probability data table of the storage circuit 104.

In this manner, the cluster probability estimation unit 124 estimates the probability of each word for a word belonging to each of the plurality of generated word clusters. Further, the cluster probability estimation unit 124 estimates the probability of each word using the obtained positional relationship and the aggregated appearance frequency.

### 1.6 Cluster Estimation Unit 113

The cluster estimation unit 113 (selection unit) selects a representative word cluster including a word related to a topic representing description content of the document from a plurality of word clusters for each document (language data). Further, the cluster estimation unit 113 selects the representative word cluster from the plurality of word clusters by using the probability of each word estimated for each of the plurality of word clusters.

As described above, the cluster estimation unit 113 includes the representative word cluster estimation unit 125.

In the above example, a plurality of word clusters is generated for each document.

In a case where a plurality of word clusters is generated for each document, the representative word cluster estimation unit 125 selects one word cluster as the representative word cluster from the plurality of generated word clusters as described below.

The representative word cluster estimation unit 125 multiplies probabilities included in the cluster probability data table 158a for a plurality of words included in the noun phrase data 153a for one word cluster of the document 152a, for example.

For example, the noun phrase data 153a includes words “National Diet”, “deliberation”, “Olympics”, “association”, “bill”, . . . , as illustrated in FIG. 4. Further, it is assumed that probabilities of the words “National Diet”, “deliberation”, “Olympics”, “association”, “bill”, . . . are P1, P2, P3, P4, P5, . . . , according to the cluster probability data table 158a.

Note that each probability is expressed by a percentage (%).

It is calculated by the total multiplication value (index value) =P1×P2×P3×P4×P5×. . . , in this case.

Here, the noun phrase data 153a includes three words “bill” as an example, and thus the probability corresponding to the word “bill” is multiplied three times in the calculation of the total multiplication value.

For example, the representative word cluster estimation unit 125 also calculates the total multiplication value for other word clusters of the document 152a similarly to as described above.

In this way, for example, the total multiplication value is calculated for a plurality of word clusters of the document 152a.

In this manner, for example, the representative word cluster estimation unit 125 generates the topic distribution 156a for each document illustrated in FIG. 6 for the document 152a. In the topic distribution 156a, a horizontal axis represents a topic, and a vertical axis represents the total multiplication value (index value) of each word cluster, that is, of each topic.

The representative word cluster estimation unit 125 selects the largest total multiplication value among the plurality of calculated total multiplication values, and selects a word cluster from which the selected total multiplication value is calculated as a representative word cluster.

The representative word cluster estimation unit 125 also calculates the total multiplication value (index value) by each word cluster for the documents 152b and 152c similarly to as described above.

For example, the representative word cluster estimation unit 125 generates topic distributions 156b and 156c for each document illustrated in FIG. 6 for the documents 152b and 152c. In each of the topic distributions 156b and 156c, a horizontal axis represents a topic, and a vertical axis represents the total multiplication value (index value) of each word cluster, that is, of each topic.

The representative word cluster estimation unit 125 also selects representative word clusters for the documents 152b and 152c similarly to as described above.

Note that the representative word cluster estimation unit 125 calculates the total multiplication value=P1×P2×P3×P4×P5×. . . as described above. However, the embodiment is not limited to this method.

The representative word cluster estimation unit 125 may calculate the total sum value (index value)=P1+P2+P3+P4+P5+. . . , select the largest total sum value among the plurality of calculated total sum values, and select the word cluster from which the selected total sum value is calculated as the representative word cluster.

As described above, the representative word cluster estimation unit 125 of the cluster estimation unit 113 (selection unit) selects the representative word cluster by summing or multiplying a plurality of probabilities estimated for each of a plurality of words included in the document (language data) for each word cluster, calculating an index value indicating likelihood of representing description content of the document by the word cluster, and comparing a plurality of index values calculated for the plurality of word clusters.

Here, the number of representative word clusters selected by the cluster estimation unit 113 (selection unit) is smaller than the number of a plurality of word clusters generated by the word processing unit 112.

### 1.7 Summary Unit 114

The summary unit 114 (extraction unit) generates a summary text from each document (language data) on the basis of the representative word cluster selected by the representative word cluster estimation unit 125.

That is, the summary unit 114 extracts a sentence (that is, a sentence representing the description content of the document) including a word included in the representative word cluster from each document using the word included in the representative word cluster, and generates a summary text including the extracted sentence.

An example of a summary generated by the summary unit 114 is illustrated in FIG. 9. The summary 191 illustrated in this diagram includes all or part of the words included in the word cluster 157a illustrated in FIG. 7A selected as the representative word cluster.

### 1.8 Screen Example

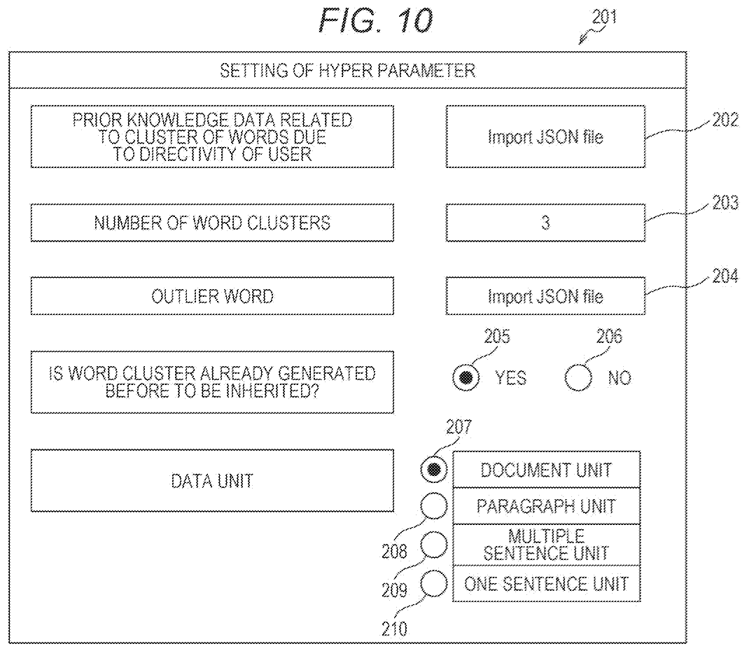

An example of a screen displayed on the information processing apparatus 10 is illustrated in FIG. 10.

A screen 201 illustrated in this diagram is a screen for requesting the user for input in order to set a hyperparameter set in the information processing apparatus 10.

As illustrated in this diagram, the screen 201 includes input fields 202, 203, and 204, and radio buttons 205, 206, and 207 to 210.

The input fields 202, 203, and 204 are fields in which the user performs an input operation in order to receive inputs of prior knowledge data, the number of word clusters, and outlier words, respectively. The radio buttons 205 and 206 are radio buttons for setting whether or not to inherit the word cluster. Either of the radio buttons 205 and 206 is selected by the user. The radio buttons 207, 208, 209, and 210 are radio buttons for selecting any one of a document unit, a paragraph unit, multiple sentence unit, and one sentence unit, respectively, as a data unit. Any one of the radio buttons 207, 208, 209, and 210 is selected by the user.

The integrated control unit 110 generates the screen 201 and outputs the generated screen 201 to the monitor 107 via the input-output circuit 105. The monitor 107 displays the screen 201.

The keyboard 108 and the mouse 109 receive an operation instruction of the user in the input fields 202, 203, and 204 and the radio buttons 205 to 210, and output an instruction signal corresponding to the received operation instruction to the integrated control unit 110 via the input-output circuit 105.

The integrated control unit 110 executes processing according to the received instruction signal.

Note that the prior knowledge data, the number of word clusters, outlier words, whether or not to inherit the word clusters, and the data unit will be described next.

### 1.9 Prior Knowledge Data

The prior knowledge data (prior knowledge information) is data indicating a word related to a topic. In other words, the prior knowledge data is used to classify words so that words related to one topic belong to one word cluster. In this manner, information indicating which word cluster a word belongs to is given in advance in accordance with directivity of the user.

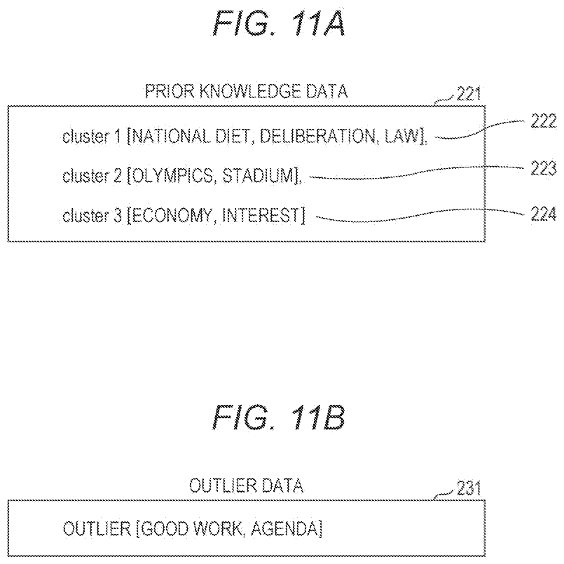

As illustrated in FIG. 11A as an example, the prior knowledge data 221 includes word clusters 222, 223, and 224. The word cluster 222 includes the words “National Diet”, “deliberation”, and “law”. The word cluster 223 includes the words “Olympics” and “stadium”. The word cluster 224 includes the words “economy” and “interest rate”.

In the prior knowledge data 221, a JSON format is used as a data format, and a word to be registered in advance is described for each word cluster.

The prior knowledge data is generated in advance by the user. The generated prior knowledge data is stored in the storage circuit 104 according to an operation instruction of the user.

The word cluster generation unit 123 classifies the words included in the document using the prior knowledge data stored in the storage circuit 104, and generates a plurality of word clusters.

Description will be made using the prior knowledge data 221 illustrated in FIG. 11A.

In a case where the words “National Diet”, “deliberation”, and “law” included in the word cluster 222 are included in the document, the word cluster generation unit 123 determines that the document corresponds to the word cluster 222. Further, in a case where the words “Olympics” and “stadium” included in the word cluster 223 are included in the document, the word cluster generation unit 123 determines that the document corresponds to the word cluster 223. Further, in a case where the words “economy” and “interest rate” included in the word cluster 224 are included in the document, the word cluster generation unit 123 determines that the document corresponds to the word cluster 224.

In this manner, it is possible to prepare the prior knowledge data indicating the word related to the topic in advance and sequentially generate the word cluster from the words included in the document using the prior knowledge data as the teacher data.

Specifically, in a case where a user who requests the summary of a document of meeting minutes participates in the target meeting, it is possible to bring the generated summary text close to the summary intended by the user by giving a word cluster in advance using words considered to have high importance in accordance with the directivity of the user as prior knowledge.

### 1.10 Number of Word Clusters

The keyboard 108 may receive designation of the number of word clusters to be generated from the user. The keyboard 108 outputs the received number of word clusters to the integrated control unit 110 via the input-output circuit 105.

The word processing unit 112 receives the number of word clusters from the integrated control unit 110.

The word cluster generation unit 123 generates the designated number of word clusters.

The user can designate the number of word clusters in the following cases, for example.

When the user who has participated in a meeting to be summarized requests the information processing apparatus 10 for summary, the user may be able to clearly designate the number of word clusters in advance. Specifically, there is a case where an agenda is determined in advance at the start of the meeting, and the meeting is proceeding according to the agenda. For example, there is a case where a brainstorming within a team is performed as an example, in which (a) a medical idea is discussed for a period of time, then (b) a construction-related idea is discussed, and finally (c) an agenda for an office solution is discussed. In such a case, the words appearing in the topics of (a), (b), and (c) are greatly different, and thus the user can designate three word clusters in advance. The information processing apparatus 10 generates a designated number of word clusters.

### 1.11 Outlier Word

The storage circuit 104 may store in advance outlier data (outlier information) indicating a word not related to the topic desired by the user (that is, indicating a word that is not similar to any word related to the topic desired by the user). In this case, the word cluster generation unit 123 excludes the word indicated by the outlier data when classifying the word included in the document.

As an example, the outlier data 231 illustrated in FIG. 11B includes “good work” and “agenda”. When classifying the words included in the document, the word cluster generation unit 123 excludes the words “good work” and “agenda” indicated by the outlier data.

Cases where such a word appears include sentences that appear regularly in a meeting, such as “Today's agenda is as follows.” and “This is the end of the meeting. Good work.” The word “agenda” in “Today's agenda is as follows.” and the words “good work” or the like in “This is the end of the meeting. Good work.” are considered to be irrelevant to the topic of the meeting and are appropriate to be excluded from the classification.

In this manner, when the words in the document are classified so that related words belong to one word cluster, a word that is not similar to any word existing in the document may be regarded as an outlier and may be determined not to be considered.

### 1.12 Whether or not to Inherit Word Cluster

In a plurality of meetings, one theme may be continuously discussed. Examples thereof include a weekly report meeting and a regular meeting at a development meeting, and the like. In such a case, the word cluster generated from a document representing the content of a first meeting can be used again when the word cluster is generated from a document representing the content of a second meeting.

Thus, according to an operation instruction from the user, the word cluster generation unit 123 writes and stores the word cluster generated from the document representing the content of the first meeting in the storage circuit 104.

In this case, the cluster estimation unit 113 may write the estimated representative word cluster in the storage circuit 104.

The word cluster generation unit 123 may use the word cluster of the first meeting stored in the storage circuit 104 when generating the word cluster from the document representing the content of the second meeting according to the operation instruction of the user.

By using the word cluster generated and stored by the previous meeting, it is possible to refer to the word cluster having high importance in the previous meeting, and it is possible to extract information (summary) having higher importance in this meeting.

Further, a designation of the word cluster to be deleted may be received from the user by the keyboard 108 (receiver). The keyboard 108 outputs the received designation of the word cluster to be deleted to the integrated control unit 110 via the input-output circuit 105.

The word processing unit 112 receives the received designation of the word cluster to be deleted from the integrated control unit 110. The word cluster generation unit 123 deletes the designated word cluster from the storage circuit 104.

Cases of deleting the information of the word cluster include a case of one-time meeting. In situations of brainstorming, a chat, and the like, the discussion may be completed only by the meeting. In such a case, the word cluster stored in the storage circuit 104 may be deleted according to an operation instruction of the user.

Further, in a case where a plurality of word clusters is generated and stored in the storage circuit 104 in the first meeting among meetings performed continuously, a word cluster that the user can clearly recognize as unusable in the next meeting among the plurality of word clusters may be deleted from the storage circuit 104 according to an operation instruction of the user.

### 1.13 Data Unit

By using any one of the entire language data including a plurality of documents, an entire document included in the language data, a paragraph included in the document, a plurality of sentences included in the document, and one sentence included in the document as a data unit, the word cluster generation unit 123 may classify words included in the data unit for each data unit and generate a plurality of word clusters for each data unit. The data unit is a unit for determining a topic.

The cluster estimation unit 113 selects a representative word cluster from a plurality of word clusters for each data unit.

Further, a designation of the data unit may be received from the user by the keyboard 108 (receiver). The keyboard 108 outputs the received designation of the data unit to the integrated control unit 110 via the input-output circuit 105.

The word cluster generation unit 123 classifies the word for each data unit received from the user.

In the present embodiment, in order to classify topics for discussion at one meeting, as described above, the data unit may be a designated unit of a plurality of sentences or a unit of one sentence. Further, the sentences may be classified into clusters for each sentence so that a discussion that has suddenly occurred again can be handled.

Further, the summary unit 114 may extract, by each data unit, a sentence representing description content of the data unit from the data unit as a summary.

### 1.14 Operation in Information Processing Apparatus 10

An operation in the information processing apparatus 10 will be described with reference to a flowchart.

(1) Overall Operation of Information Processing Apparatus 10

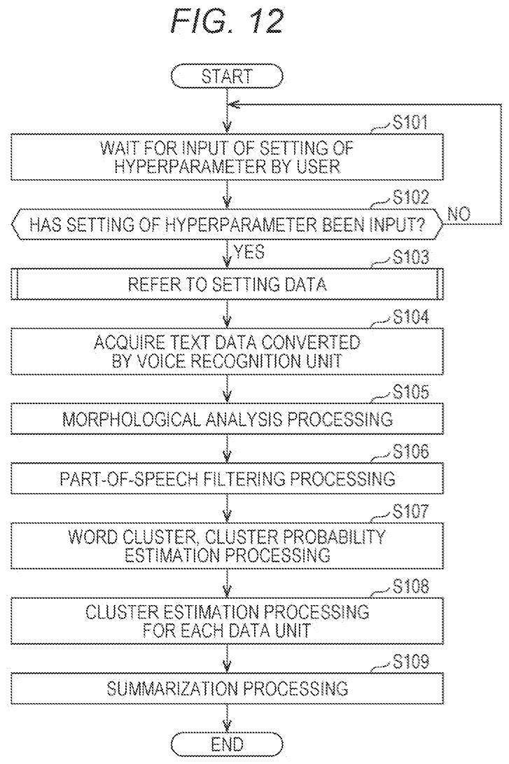

An overall operation of the entire information processing apparatus 10 will be described with reference to a flowchart illustrated in FIG. 12.

The integrated control unit 110 waits for an input of hyperparameter setting by the user (step S101). When no hyperparameter setting has been input (“NO” in step S102), the integrated control unit 110 shifts the control to step S101 and repeats the processing.

When the setting of the hyperparameter is input (“YES” in step S102), the integrated control unit 110 refers to the setting data (step S103).

The voice recognition unit 111 acquires text data converted by voice recognition from the voice data (step S104).

The morphological analysis unit 121 performs morphological analysis to generate morphemes (step S105).

The part-of-speech filtering unit 122 extracts a noun phrase from the morpheme (step S106).

The word cluster generation unit 123 generates a word cluster, and the cluster probability estimation unit 124 estimates a probability for each word (step S107).

The cluster estimation unit 113 selects a representative word cluster from a plurality of word clusters for each data unit (step S108).

The summary unit 114 generates a summary text for each document by using the representative word cluster selected by the representative word cluster estimation unit 125 (step S109).

This is the end of the description of the operation in the information processing apparatus 10.

(2) Operation of Referring to Setting Data

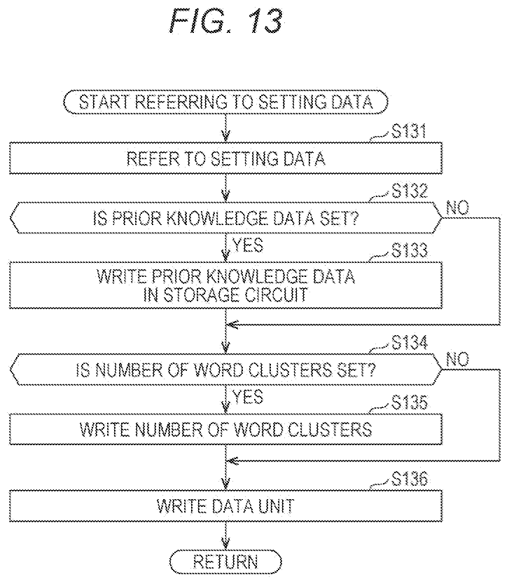

An operation of referring to setting data will be described with reference to a flowchart illustrated in FIG. 13.

Note that the operation described here is details of the procedure in step S103 in FIG. 12.

The integrated control unit 110 refers to the setting data (hyperparameter) set by the user (step S131).

The integrated control unit 110 determines whether or not the prior knowledge data is set (step S132). When the prior knowledge data is set (“YES” in step S132), the integrated control unit 110 writes the prior knowledge data in the storage circuit 104 (step S133).

Next, the integrated control unit 110 determines whether or not the number of word clusters is set by the user (step S134). When the number of word clusters is set (“YES” in step S134), the integrated control unit 110 writes the number of word clusters in the storage circuit 104 (step S135).

Next, the integrated control unit 110 writes the data unit in the storage circuit 104 (step S136).

Thus, the description of the operation of referring to the setting data ends.

(3) Processing of Outlier

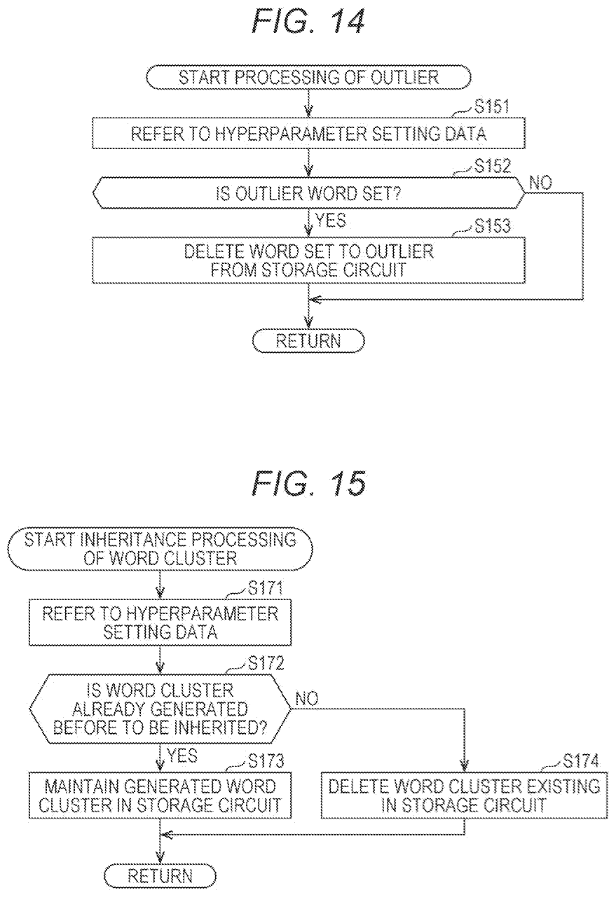

Processing of outlier will be described with reference to a flowchart illustrated in FIG. 14.

The word cluster generation unit 123 refers to the setting data (hyperparameter) set by the user (step S151).

Next, the word cluster generation unit 123 determines whether or not an outlier word is set (step S152). When an outlier word is set (“YES” in step S152), the word cluster generation unit 123 deletes the outlier word from the word cluster stored in the storage circuit 104 (step S153).

This is the end of the description of the outlier processing.

(4) Word Cluster Inheritance Processing

Word cluster inheritance processing will be described with reference to a flowchart illustrated in FIG. 15.

The integrated control unit 110 refers to the setting data (hyperparameter) set by the user (step S171).

Next, the integrated control unit 110 determines whether or not a setting to inherit the already generated word cluster has been made (step S172). When the setting to inherit has been made (“YES” in step S172), the integrated control unit 110 maintains a storage state of the generated word cluster in the storage circuit 104 (step S173). When the setting to inherit has not been made (“NO” in step S172), the integrated control unit 110 deletes the word cluster existing in the storage circuit 104. In this case, all the word clusters existing in the storage circuit 104 may be deleted, or only the word cluster designated by the user may be deleted (step S174).

Thus, the description of the word cluster inheritance processing ends.

### 1.15 Example (1)

In the above exemplary embodiment, the voice recognition unit 111 performs the voice recognition processing on the voice data to generate text data.

However, the embodiment is not limited to this mode.

One aspect of the present disclosure may be a system including the information processing apparatus 10 and a server apparatus. The information processing apparatus 10 and the server apparatus are connected via a network. The server apparatus provides voice recognition processing as one of cloud services. That is, the server apparatus receives the voice data and converts the received voice data into text data to generate a document.

The information processing apparatus 10 may use voice recognition processing provided by the server apparatus.

The information processing apparatus 10 includes a network communication circuit connected to a server apparatus via a network. Under the control of the integrated control unit 110, the network communication circuit transmits the voice data to the server apparatus, and requests the server apparatus to perform voice recognition processing on the voice data.

The server apparatus includes a network communication circuit (communicator) and a voice recognition circuit (voice recognition unit). The voice recognition circuit of the server apparatus has a configuration similar to that of the voice recognition unit 111 of the information processing apparatus 10.

The network communication circuit of the server apparatus receives a request for the voice recognition processing on the voice data together with the voice data from the information processing apparatus 10 via the network. When the voice data is received together with the request, the voice recognition circuit converts the received voice data into text data and generates a document including the text data. The network communication circuit of the server apparatus transmits the generated document to the information processing apparatus 10 via the network.

The network communication circuit of the information processing apparatus 10 receives the document from the server apparatus, and writes the received document in the storage circuit 104.

### 1.16 Example (2)

The morphological analysis unit 121 of the information processing apparatus 10 may use a known morphological analysis method. The morphological analysis unit 121 may use, for example, any of known MeCab, JUMAN, KyTea, and ChaSen.

### 1.17 Example (3)

The word cluster generation unit 123 and the cluster probability estimation unit 124 may use various known natural language processing techniques. For example, as a method of estimating a latent topic of text data from words appearing in the text data, there is LDA or the like. The LDA is a document classification model based on the assumption that text data has a plurality of topics. In this method, the latent topic is estimated by sequentially learning the appearance frequencies and the positional relationship of words only from target text data.

Note that the latent topic is a set of important words clustered for each topic, and has a topic probability (or merely probability) indicating how likely each of the words is to belong to a topic. The sentence is classified for each latent topic by using the latent topic.

Thus, the word cluster generation unit 123 generates a plurality of word clusters. A word cluster is a word set in which words are clustered as elements that can constitute a topic.

Further, the cluster probability estimation unit 124 obtains a probability of belonging to the topic for each of the clustered words.

### 1.18 Example (4)

The summary unit 114 may use various known natural language processing techniques.

For example, LexRank or the like is exemplified as a method of extracting an important sentence by scoring a sentence that can be important of text data from words appearing in the text data.

When LexRank is applied, for words included in the representative word cluster, eigenvector centricity is calculated by graph representation of similarity of words appearing in text data, and relative importance in text units is calculated. That is, words that often appear in other sentences and are similar to important words can be regarded as important, and a sentence in which these important words appear can be regarded as important.

By generating the summary text by this method, it is possible to obtain a summary characterized by the word cluster.

### 1.19 Example (5)

There is a case where a plurality of word clusters is generated by each data unit from a document as a target of generating a word cluster.

In a case where a plurality of topics is originally included in one data unit, a plurality of word clusters is generated from the data unit.

Further, in a case where a plurality of word clusters is similar to each other, a plurality of word clusters is generated from one data unit. For example, there is a case of a word cluster related to neuroscience and a word cluster related to AI. Words belonging to both the word clusters are likely to include the same words, and it can be said that the word clusters are similar to each other between the word cluster related to neuroscience and the word cluster related to AI.

### 1.20 Example (6)

The data amount of a summary (that is, the character amount of the summary) may be designated by the user before the summary is generated from the document. That is, the integrated control unit 110 can receive the data amount of the summary from the keyboard 108 via the input-output circuit 105 according to an operation instruction of the user.

The summary unit 114 generates a summary within the designated data amount of the summary.

For example, in a case where the summary unit 114 initially generates a 500 character summary including 5 sentences, if 300 characters are designated by the user as the character amount, the summary unit 114 deletes one sentence among the five sentences. The summary unit 114 counts the number of characters of the summary after deleting one sentence. If the number of characters of the deleted summary is 300 or less, the summary unit 114 determines the summary after deletion of one sentence. On the other hand, in a case where the number of characters of the summary after deletion exceeds 300 characters, one sentence is further deleted. In this manner, the above processing is repeated until the number of characters of the summary after deletion becomes 300 characters or less designated by the user.

By appropriately designating the data amount of the summary by the user in this manner, it is possible to suppress a situation in which the data amount of the summary is too large to play a role as a summary that should be concise and a situation in which the data amount of the summary is too small to understand the main point of the discussion in the summary.

Note that the integrated control unit 110 may receive the number of sentences of the summary from the keyboard 108 via the input-output circuit 105 according to an operation instruction of the user. In this case, the summary unit 114 generates a summary within the number of designated sentences.

Also in this case, similarly to as described above, when the number of sentences exceeds the number designated by the user, the summary unit 114 repeats deletion of the sentences in the summary until the number of sentences becomes equal to or less than the number designated by the user.

### 1.21 Example (7)

As described above, by using any one of the entire language data including a plurality of documents, an entire document included in the language data, a paragraph included in the document, a plurality of sentences included in the document, and one sentence included in the document as a data unit, the word processing unit 112 may classify words included in the data unit for each data unit.

The cluster estimation unit 113 (selection unit) may include a cluster analysis unit (analysis unit) that determines, for each representative word cluster, the importance of this representative word cluster.

Further, the cluster analysis unit may aggregate, for each representative word cluster, the number or amount of data units corresponding to this representative word cluster, and determine the importance of the representative word cluster according to the aggregated value for each representative word cluster.

Further, in a case where the aggregated value of one representative word cluster exceeds a predetermined value, the cluster analysis unit may set the importance of the representative word cluster to a predetermined maximum value.

(1) For example, when there are eight data units corresponding to a representative word cluster a, there are four data units corresponding to a representative word cluster b, and there are two data units corresponding to a representative word cluster c, the cluster analysis unit may set the importance of each representative word cluster such that the importance of the representative word cluster a>the importance of the representative word cluster b>the importance of the representative word cluster c for the representative word clusters a, b, and c.

That is, the cluster analysis unit may set the importance of the representative word cluster according to the number of data units corresponding to the representative word cluster. In this case, the importance of the representative word cluster is set higher as the number of data units is larger, and the importance of the representative word cluster is set lower as the number of data units is smaller.

In this manner, the importance set for each representative word cluster may be presented to the user. That is, the cluster analysis unit outputs the set importance for each representative word cluster to the monitor 107 via the integrated control unit 110 and the input-output circuit 105. The monitor 107 outputs the set importance for each representative word cluster.

(2) Even in a case where low importance is set for a certain representative word cluster by the cluster analysis unit, when it is determined that the importance of the representative word cluster is high for the user, the importance of the representative word cluster may be set high.

Conversely, even in a case where high importance is set for a certain representative word cluster by the cluster analysis unit, when it is determined that the importance of the representative word cluster is low for the user, the importance of the representative word cluster may be set low.

In this manner, the importance of the representative word cluster may be changed according to the intention of the user.

The integrated control unit 110 may receive a change in the importance of the representative word cluster from the keyboard 108 via the input-output circuit 105 according to an operation instruction of the user.

The cluster analysis unit changes the importance of the representative word cluster to the importance received according to the operation instruction of the user.

In the case of (1), when the user determines that the importance of the representative word cluster c is the highest, the cluster analysis unit changes the setting of the importance of each representative word cluster such that the importance of the representative word cluster c>the importance of the representative word cluster a>the importance of the representative word cluster b for the representative word clusters a, b, and c.

In this manner, the importance of each representative word cluster is changed to the importance intended by the user, and consequently, a more appropriate representative word cluster reflecting the intention of the user can be selected.

(3) The data amount or the number of sentences of the summary described in the example (6) may be made variable according to the importance of the representative word cluster. That is, the summary unit 114 may vary the data amount of the summary according to the determined importance. Here, the summary unit 114 may vary the amount of characters included in the summary or the number of sentences included in the summary.

For example, in a case where the importance of the representative word cluster is high, the data amount or the number of sentences of the summary may be increased, and in a case where the importance of the representative word cluster is low, the data amount or the number of sentences of the summary may be decreased.

In a case where the importance of each representative word cluster is set such that the importance of the representative word cluster a>the importance of the representative word cluster b>the importance of the representative word cluster c as in the case of (1), it is assumed that the summary of the representative word cluster a includes four sentences, the summary of the representative word cluster b includes two sentences, and the summary of the representative word cluster c includes one sentence.

A reason for that the data amount or the number of sentences of the summary is made variable depending on the importance of the representative word cluster in this manner is to increase the possibility of being capable of providing the information (summary) that the user intends to obtain with respect to such a representative word cluster because the information amount of the main representative word cluster is large.

### 1.22 Example (8)

As described above, the word cluster generation unit 123 sets any one of the entire language data including a plurality of documents, an entire document included in the language data, a paragraph included in the document, a plurality of sentences included in the document, and one sentence included in the document as a data unit. Here, a case where each of an entire document and a paragraph included in the document is a data unit will be specifically described.

(1) In a Case where the Entire Document is a Data Unit

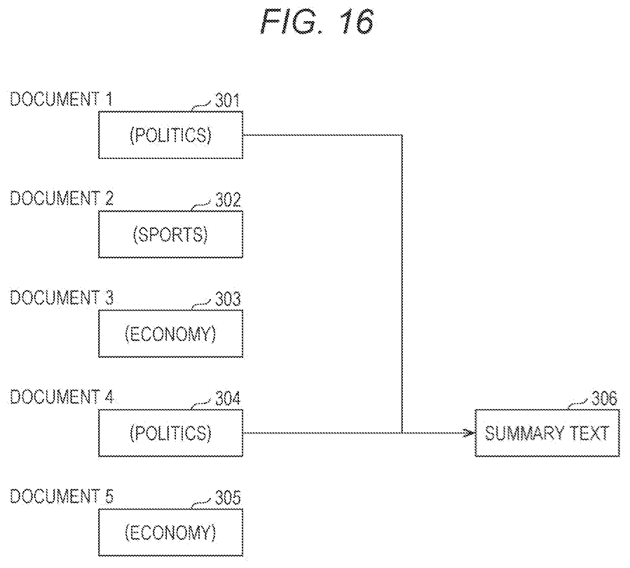

A case where the entire document is a data unit will be described with reference to FIG. 16.

As illustrated in this diagram, it is assumed that language data including a plurality of documents 301, 302, 303, 304, and 305 is a target of summary generation. Further, it is assumed that the cluster estimation unit 113 has selected a representative word cluster having “politics”, “sports”, “economy”, “politics”, and “economy” as topics for each of the plurality of documents 301, 302, 303, 304, and 305.

In this case, it is estimated that “politics” is a topic for each of the two documents 301 and 304, the summary unit 114 may generate one summary from the documents 301 and 304. In this case, the generated summary includes one or a plurality of sentences.

As described above, in a case where it is estimated that a plurality of documents has the same topic, one summary is generated from the plurality of documents, and thus the generated summary can be appropriate to simply represent the content of the plurality of documents having the same topic.

The information processing apparatus 10 (summary generation apparatus) may generate a summary from the language data including a plurality of documents. The cluster estimation unit 113 may select, for each of the plurality of documents, a representative word cluster including words related to a topic representing description content of the document from a plurality of word clusters. In a case where there is a plurality of topic documents from which the representative word cluster including words related to an identical topic is generated, the summary unit 114 may generate a summary from the plurality of topic documents on the basis of the representative word cluster.

(2) Case where Paragraph Included in Document is Data Unit

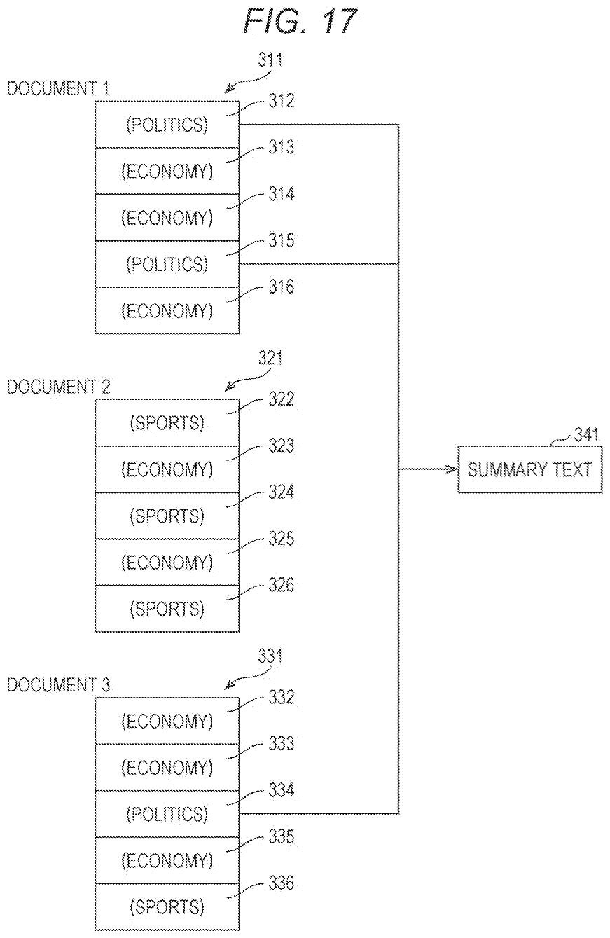

A case where a paragraph included in a document is a data unit will be described with reference to FIG. 17.

As illustrated in this diagram, it is assumed that language data including a plurality of documents 311, 321, and 331 is a target of summary generation. Further, it is assumed that the document 311 includes a plurality of paragraphs 312, 313, 314, 315, and 316, the document 321 includes a plurality of paragraphs 322, 323, 324, 325, and 326, and the document 331 includes a plurality of paragraphs 332, 333, 334, 335, and 336.

Here, it is assumed that the cluster estimation unit 113 selects representative word clusters having “politics”, “economy”, “economy”, “politics”, and “economy” as topics for each of the paragraphs 312, 313, 314, 315, and 316 of the document 311.

Further, it is assumed that the cluster estimation unit 113 selects a representative word cluster having “sports”, “economy”, “sports”, “economy”, and “sports” as topics for each of the paragraphs 322, 323, 324, 325, and 326 of the document 321.

Furthermore, it is assumed that the cluster estimation unit 113 selects a representative word cluster having “economy”, “economy”, “politics”, “economy”, and “sports” as topics for each of the paragraphs 332, 333, 334, 335, and 336 of the document 331.

In this case, it is estimated that “politics” is a topic for each of the paragraphs 312 and 315 of the document 311 and the paragraph 334 of the document 331, the summary unit 114 may generate one summary from the paragraphs 312 and 315 of the document 311 and the paragraph 334 of the document 331. In this case, the generated summary includes one or a plurality of sentences.

As described above, in a case where there is a plurality of paragraphs estimated to have the same topic for a plurality of documents each including a plurality of paragraphs, one summary is generated from the plurality of paragraphs, and thus the generated summary can appropriately represent the content of the plurality of paragraphs having the same topic in a concise manner.

Note that in a case where there is a plurality of paragraphs estimated to have the same topic for one document including a plurality of paragraphs, one summary may be generated from the plurality of paragraphs.

The word processing unit 112 may classify a word included in the data unit for each data unit and generate a plurality of word clusters for each data unit. The cluster estimation unit 113 may select a representative word cluster from a plurality of word clusters for each data unit.

As described above, the summary unit 114 may extract a summary from a plurality of data units.

Further, the summary unit 114 may extract a summary from a plurality of data units of a plurality of documents.

### 1.23 Summary

As described above, the cluster estimation unit 113 selects a representative word cluster including words related to a topic representing description content of a document from a plurality of generated word clusters, and thereby a summary representing the representative topic can be generated using the representative word cluster.

A summary generation apparatus according to the present disclosure has an effect of being capable of generating a summary representing a representative topic, and is useful as a technique for summarizing a document.

Although embodiments of the present invention have been described and illustrated in detail, the disclosed embodiments are made for purposes of illustration and example only and not limitation. The scope of the present invention should be interpreted by terms of the appended claims.

What is claimed is:

1. A summary generation apparatus that generates a summary from language data, the summary generation apparatus comprising
a hardware processor that:
classifies a word included in the language data and generates a plurality of word clusters in such a manner that words having a possibility of being related to one topic belong to an identical word cluster;
selects a representative word cluster including words related to a topic representing description content of the language data from the plurality of word clusters; and
generates a summary from the language data on the basis of the representative word cluster.

2. The summary generation apparatus according to claim 1, wherein
the hardware processor:
estimates a probability indicating a degree of a possibility that each word belonging to each generated word cluster belongs to a topic corresponding to the word cluster; and
selects the representative word cluster from the plurality of word clusters by using a probability of each word estimated for each of the plurality of word clusters.

3. The summary generation apparatus according to claim 2, wherein
the hardware processor selects the representative word cluster by summing or multiplying probabilities estimated for each of a plurality of words included in the language data for each word cluster, calculating an index value indicating likelihood of representing description content of the language data by the word cluster, and comparing a plurality of index values calculated for the plurality of word clusters.

4. The summary generation apparatus according to claim 2, wherein
the hardware processor:
performs morphological analysis on the language data, generates a plurality of morphemes, and estimates a part of speech of each morpheme;
extracts a word that is a noun from a plurality of morphemes generated by the hardware processor;
classifies the extracted word to generate the plurality of word clusters; and
estimates the probability of each word belonging to each of the plurality of word clusters that has been generated.

5. The summary generation apparatus according to claim 4, wherein
the hardware processor:
obtains a positional relationship between a word and a word in the language data, aggregates an appearance frequency of the word extracted by the hardware processor for each word, and generates the plurality of word clusters using the obtained positional relationship and the aggregated appearance frequency; and
estimates a probability of each word using the obtained positional relationship and the aggregated appearance frequency.

6. The summary generation apparatus according to claim 1, wherein
the hardware processor:
converts voice data to generate the language data; and
generates the plurality of word clusters from the language data that has been generated.

7. The summary generation apparatus according to claim 1, further comprising
a storage that stores in advance prior knowledge information indicating a word related to one topic, wherein
the hardware processor classifies a word included in the language data using the prior knowledge information.

8. The summary generation apparatus according to claim 1, further comprising
a receiver that receives a designation of a number of word clusters to be generated from a user, wherein
the hardware processor generates a designated number of word clusters.

9. The summary generation apparatus according to claim 1, further comprising
a storage that stores in advance outlier information indicating a word not related to a topic desired by a user, wherein
the hardware processor excludes a word indicated by the outlier information when classifying a word included in the language data.

10. The summary generation apparatus according to claim 1, wherein
the language data includes a plurality of documents, and
the hardware processor:
sets any one of the entire language data, a document included in the language data, a paragraph included in the document, a plurality of sentences included in the document, and one sentence included in the document as a data unit, classifies a word included in the data unit for each data unit, and generates the plurality of word clusters for each data unit; and
selects the representative word cluster from the plurality of word clusters for each data unit.

11. The summary generation apparatus according to claim 10, further comprising
a receiver that receives a designation of the data unit from a user, wherein
the hardware processor classifies each data unit received from a user.

12. The summary generation apparatus according to claim 10, wherein
the hardware processor generates, for each data unit, the summary from the data unit.

13. The summary generation apparatus according to claim 1, wherein
the hardware processor further determines, for each representative word cluster, importance of the representative word cluster.

14. The summary generation apparatus according to claim 13, wherein
the hardware processor varies a data amount of the summary according to the determined importance.

15. The summary generation apparatus according to claim 13, further comprising:
a display; and
a receiver that receives an input from a user, wherein
the display displays the determined importance for the each representative word cluster,
the receiver receives a change in the importance from a user for the each representative word cluster, and
the hardware processor changes the importance of the representative word cluster to the importance received from the user.

16. The summary generation apparatus according to claim 1, wherein
the number of the representative word clusters selected by the hardware processor is smaller than the number of the plurality of word clusters generated by the hardware processor.

17. The summary generation apparatus according to claim 1, wherein
the language data includes a plurality of documents, and
the hardware processor:
selects, for each of the plurality of documents, a representative word cluster including a word related to a topic representing description content of the document from the plurality of word clusters; and
generates, when there is a plurality of topic documents from which the representative word cluster including words related to an identical topic is generated, a summary from the plurality of topic documents on the basis of the representative word cluster.

18. The summary generation apparatus according to claim 17, wherein
the hardware processor:
sets any one of the entire language data, a document included in the language data, a paragraph included in the document, a plurality of sentences included in the document, and one sentence included in the document as a data unit, classifies a word included in the data unit for each data unit, and generates the plurality of word clusters for each data unit;
selects the representative word cluster from the plurality of word clusters for each data unit; and
generates the summary from a plurality of data units in the plurality of topic documents.

19. A system comprising the summary generation apparatus according to claim 1 and a server apparatus that generates language data from voice data, wherein
the server apparatus includes:
a communicator that receives voice data and transmits language data generated from the received voice data to the summary generation apparatus; and
a hardware processor that converts the received voice data to generate the language data.

20. A control method used in a summary generation apparatus that generates a summary from language data, the control method comprising:
classifying a word included in the language data and generating a plurality of word clusters in such a manner that words having a possibility of being related to one topic belong to an identical word cluster;
selecting a representative word cluster including words related to a topic representing description content of the language data from the plurality of word clusters; and
generating a summary from the language data on the basis of the representative word cluster.
